(19) United States
(12) Patent Application Publication
(10) Pub. No.: US 2023/0113939 A1
(43) Pub. Date: Apr. 13, 2023

(54) MODULAR MULTI-COOKER

(71) Applicant: Spectrum Brands, Inc., Middleton, WI (US)

(72) Inventors: Sean P. Holinka, Madison, WI (US); Benjamin M. Cleppe, Verona, WI (US); Darek J. Koszylko, Dane, WI (US); Firdaus S. Nandoliya, Verona, WI (US); Noah C. Pulvermacher, Madison, WI (US); Jacob D. Smith, Monona, WI (US)

(21) Appl. No.: 17/911,579

(22) PCT Filed: Sep. 25, 2020
(86) PCT No.: PCT/US2020/052751

§ 371 Date: Sep. 14, 2022

Related U.S. Application Data
(60) Provisional application No. 62/992,528, filed on Mar. 20, 2020.

(51) Int. Cl. A47J 27/00; A47J 36/32; A47J 36/02; A47J 36/06

(52) U.S. Cl. CPC A47J 27/004; A47J 36/32; A47J 36/02; A47J 36/06

(57) ABSTRACT

A modular cooking appliance includes a cooking vessel having a bowl unit, a lower portion of the bowl unit in contact with a heating unit having an electrical connection, a base unit attachable to and configured to support the cooking vessel, and a control unit operatively connected to the electric connection of the heating unit. The control unit includes one or more controls, and the control unit is configured to interface with and selectively provide power to the heating unit via the electrical connection such that the bowl unit of the cooking vessel is selectively heatable by the heating unit.

### PRIORITY CLAIM

This application claims the benefit of U.S. Provisional Patent Application No. 62/992,528 filed on Mar. 20, 2020, entitled “MODULAR MULTI-COOKER,” the disclosure of which is hereby incorporated by reference in its entirety for all purposes.

### BACKGROUND

The present application relates to cooking appliances that can cook in a variety of cooking modes and settings, and more particularly to a multi-cooker with modular components.

Cooking appliances come in various configurations and types, and can be powered by electricity in domestic or commercial settings. Some types of cooking appliances include slow cookers, roasters, fryers, grills, steamers, and the like. Some cooking appliances, such as multi-cookers, can provide functionality of one or more cooking appliance types in a single appliance, and can incorporate heating control functionality that permits specialized cooking aspects. In some cases, accessories and/or parts are exchanged while using a multi-purpose heating unit, power unit, and/or control unit.

Existing multi-cookers typically have significant complexity and cost. Typical multi-cookers have a cooker body and bowl inside the body. Furthermore, multi-cookers are typically difficult to clean because they have both passive and active components that are not easily separated and/or disassembled for cleaning. Therefore, there is a need for a simpler, modular, and easier-to-clean multi-cooker.

### SUMMARY

Aspects of the invention described herein are directed to modular cooking appliances that are designed to reduce production cost while having maximum functionality and easy-to-clean parts by an end user. An example cooking appliance can be a multi-cooker that includes a single bowl that can be easily cleaned in contrast to existing multi-cookers. Digital or mechanical control components, and associated heating controls are contemplated. Manual or automatic inputs are also contemplated. Various cooking modes and settings are contemplated. Furthermore, various digital displays can be used, or a simple knob or dial can be utilized.

The cooking appliance can include separable parts that allow for cleaning or washing some parts only without affecting others. A passive cooking vessel and active power and control units can be completely separated so that the cooking vessel, which includes a bowl unit (e.g., a pot) and a base unit, can be submersible and easily washed without exposing control or power components to liquids during cleaning. Therefore, various parts of the modular cooking appliance can be completely conveniently immersed in liquid or placed in a dishwasher for cleaning. In some aspects, the heating controls can be removable from the cooking vessel using a friction-connected probe or a control module that is entirely removable from the cooking vessel as a unit using fasteners.

According to a first aspect, a modular cooking appliance is disclosed. The modular cooking appliance includes a cooking vessel having a bowl unit, a lower portion of the bowl unit in contact with a heating unit having an electrical connection. The modular cooking appliance also includes a base unit attachable to and configured to support the cooking vessel. The modular cooking appliance also includes a control unit operatively connected to the electric connection of the heating unit, where the control unit includes one or more controls, and where the control unit is configured to interface with and selectively provide power to the heating unit via the electrical connection such that the bowl unit of the cooking vessel is selectively heatable by the heating unit.

According to one embodiment, the power unit operatively connects to the heating unit of the cooking vessel using a probe-like connection. According to another embodiment, the exposed electrical connection includes at least two electrical leads. According to another embodiment, the cooking vessel is configured to be submersible in liquid when disconnected from the control unit. According to another embodiment, the control unit includes a temperature or time based cooking control. According to another embodiment, the control unit is configured to receive an input via analog or digital interface. According to another embodiment, the control unit is configured to receive an input via manual or automatic interface. According to another embodiment, the control unit selectively provides the modular cooking appliance functionality of a multi-cooker or a slow cooker. According to another embodiment, the bowl unit of the cooking vessel includes only anodized aluminum. According to another embodiment, the cooking vessel includes at least one handle. According to another embodiment, the modular cooking appliance further includes a lid configured to rest on an upper rim of the bowl unit in order to at least partially seal the open top of the bowl unit of the cooking vessel. According to another embodiment, the lid further includes at least an aperture.

According to another embodiment, the control unit includes a power unit configured to receive alternating current from a wall power socket via a power cord and convert the alternating current to direct current for use with the heating unit. According to another embodiment, the heating unit is at least partially embedded or recessed within a channel of the lower portion of the cooking vessel. According to another embodiment, the heating unit is a resistive heating unit. According to another embodiment, the electrical connection of the heating unit is external to the cooking vessel. According to another embodiment, the base unit is configured to thermally insulate the cooking vessel and heating unit from a supporting surface. According to another embodiment, the control unit includes a second electrical connection complementary to the electrical connection of the heating unit. According to another embodiment, the control unit is removably connectable to the heating unit.

According to a second aspect, a method of making a modular cooking appliance is disclosed. The method includes providing a cooking vessel having a bowl unit. The method also includes attaching a heating unit to the bowl unit, where the heating unit when attached is in contact with a lower portion of the bowl unit, and where the heating unit has an electrical connection. The method also includes providing a base unit attachable to and configured to support the cooking vessel. The method also includes operatively connecting a control unit to the electric connection of the heating unit, where the control unit includes one or more controls, and where the control unit is configured to interface with and selectively provide power to the heating unit via the electrical connection such that the bowl unit of the cooking vessel is selectively heatable by the heating unit.

These and various other features and advantages will be apparent from a reading of the following detailed description.

### BRIEF DESCRIPTION OF THE DRAWINGS

The present invention will be further explained with reference to the appended Figures, wherein like structure is referred to by like numerals throughout the several views, and wherein:

FIG. 1 is a front perspective view of a modular cooking appliance, according to various embodiments.

FIG. 2 is a top perspective view of the modular cooking appliance of FIG. 1, according to various embodiments.

FIG. 3 is a bottom perspective view of the modular cooking appliance of FIG. 1, according to various embodiments.

FIG. 4 is a top perspective view of a bowl unit of the modular cooking appliance of FIG. 1, according to various embodiments.

FIG. 5 is a bottom perspective view of a bowl unit of FIG. 4, according to various embodiments.

FIG. 6 is a top perspective view of a lid of the modular cooking appliance of FIG. 1, according to various embodiments.

FIG. 7 is a top perspective view of a base unit of the modular cooking appliance of FIG. 1, according to various embodiments.

FIG. 8 is a bottom perspective view of the base unit of FIG. 7, according to various embodiments.

FIG. 9 is a top reverse perspective view of the modular cooking appliance of FIG. 1 with certain components removed to reveal the base unit of FIG. 7 shown in combination with a control unit knob and a heating unit, according to various embodiments.

FIG. 10 is a perspective view of a removable analog control unit shown with a heating unit for use with the modular cooking appliance of FIG. 1, according to various embodiments.

FIG. 11 is a perspective view of a removable digital control unit shown with a heating unit for use with the modular cooking appliance of FIG. 1, according to various embodiments.

FIG. 12 is a top perspective view of another embodiment of a modular cooking appliance, according to various embodiments.

FIG. 13 is a bottom perspective view of the modular cooking appliance of FIG. 12, according to various embodiments.

FIG. 14 is a front perspective view of the modular cooking appliance of FIG. 12 with a probe unit removed, according to various embodiments.

FIG. 15 is a top perspective view of a probe unit for use with the modular cooking appliance of FIG. 12, according to various embodiments.

FIG. 16 is a reverse top perspective view of a base unit, probe unit, and heating unit for use with the modular cooking appliance of FIG. 12, according to various embodiments.

### DETAILED DESCRIPTION

The methods and features described herein are applicable to cooking appliances, and more specifically to modular cooking appliances that are less complex, more cost effective to manufacture, and more easily cleanable by an end user. Described embodiments of modular cooking appliances have the benefit of simple, less complex construction and also easy cleaning aspects that result from the modularity. Various embodiments of modular cooking appliances are described herein, including multi-cookers with separate components.

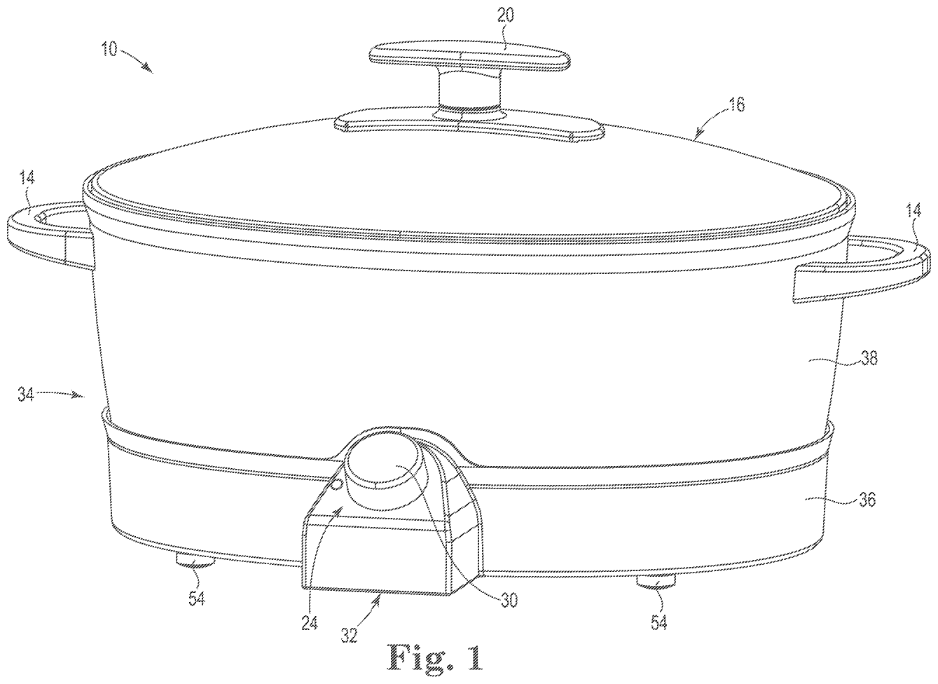

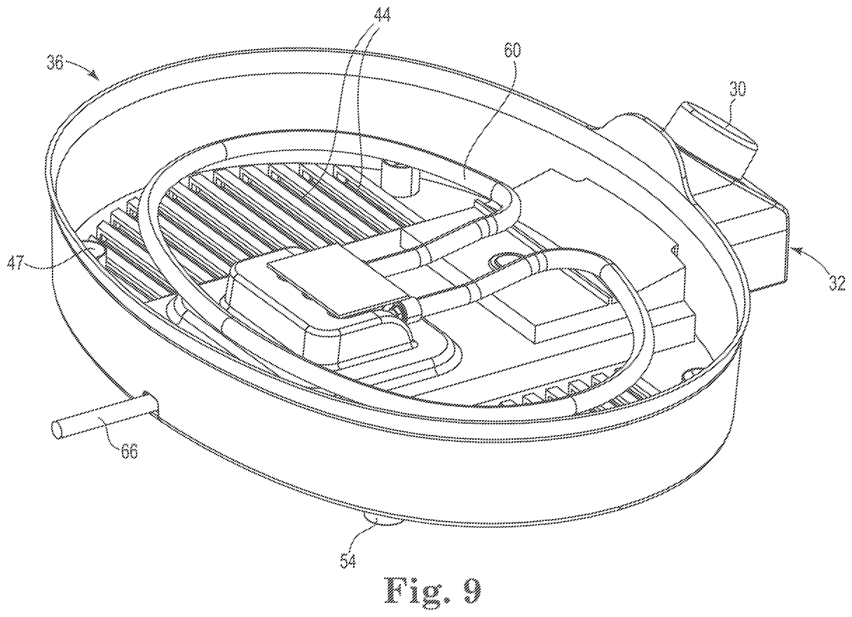

A first example of a modular cooking appliance 10 in shown with respect to FIGS. 1-11. As shown, the modular cooking appliance 10 is an example of a multi-cooker with separable components.

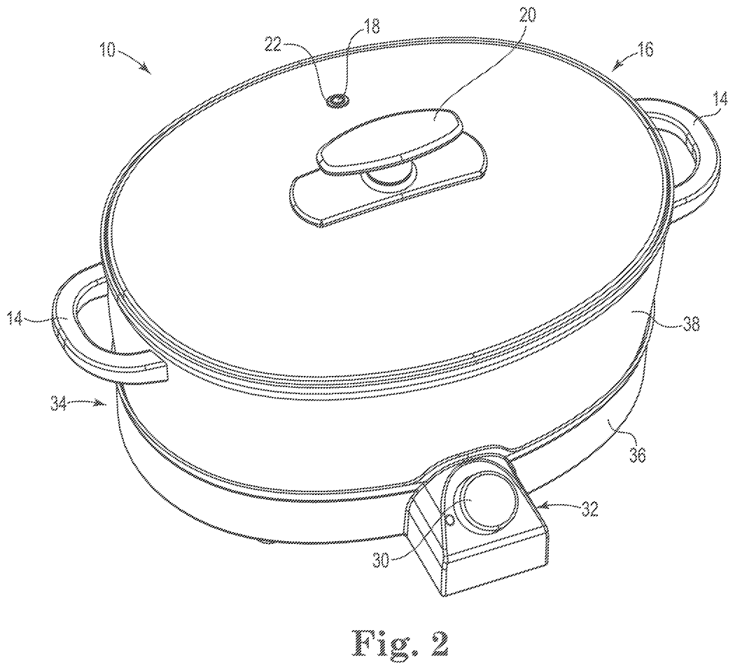

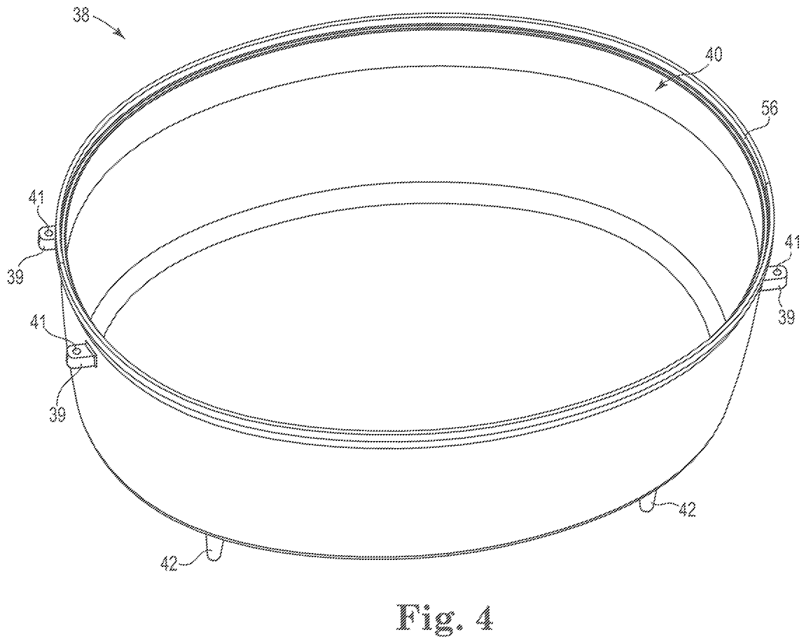

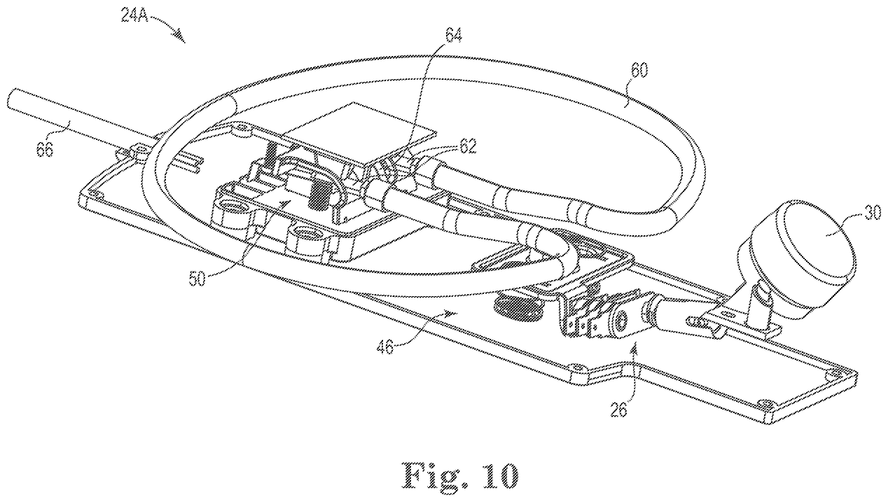

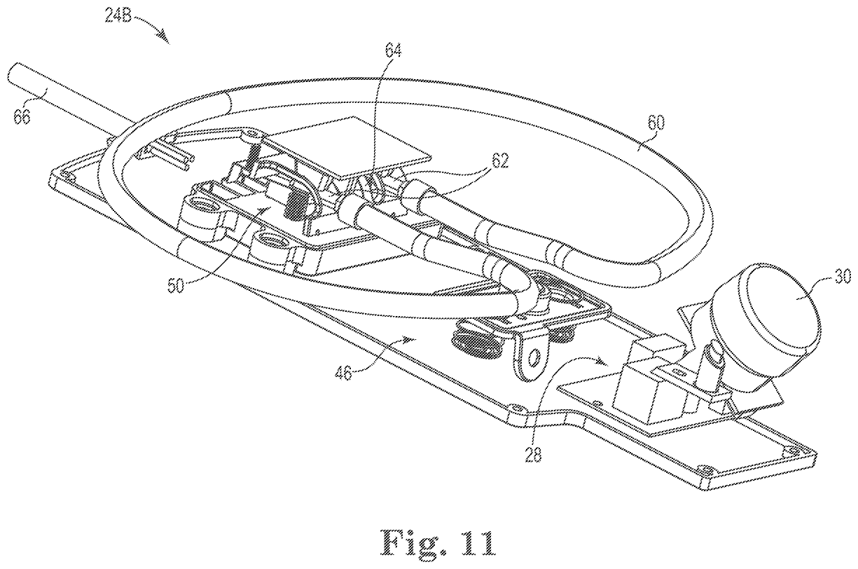

The modular cooking appliance 10 generally includes a cooking vessel 34 that comprises a bowl unit 38 and a base unit 36. The bowl unit 38 is configured to receive a food product (not shown) and can have a preferred capacity of approximately seven liters, or more or less depending on configuration. The bowl unit 38 can have a thickness of approximately 1-2 mm, or more or less depending on configuration. The bowl unit 38 is configured to interface with and be supported by the base unit 36 of the cooking vessel 34, as described in greater detail below. A removable lid 16 with an aperture 18 (see, e.g., FIG. 2) when in place upon an upper rim 56 (see FIG. 4) of the bowl unit 38 at least partially covers an interior 40 of the bowl unit 38 otherwise exposed at an open top of the bowl unit 38. A control housing 32 portion of the base unit 36 at least partially encloses or supports a control unit 24 that can include various controls such as a knob 30 for use by a user and various analog or digital control (see FIGS. 10 and 11) and power components, such as power unit 50 described below. The control housing 32 can also interface with and at least partially support a removable panel 46 and control unit 24, described in greater detail below. Embodiments that utilize automatic or digital control interfaces are also contemplated herein. Various functions can be displayed and/or selected. Handles 14 for grasping and lifting of the cooking vessel 34 of the modular cooking appliance 10 can be located at distal ends of the cooking vessel 34 (e.g., of the bowl unit 38).

Selected components of the modular cooking appliance 10 are selectively separable from one another by a user, as desired from time to time. Components can be separable by simply lifting vertically, e.g., using one or more handles such as handles 14. Alternatively components can be fastened to one another in various embodiments.

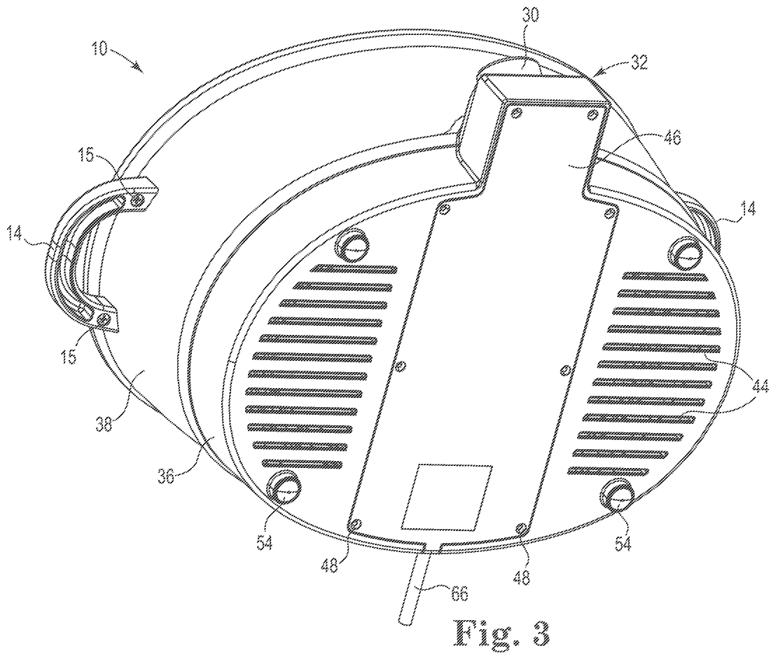

In particular, the bowl unit 38 of the cooking vessel 34 may become significantly dirty, stained, or soiled after single or multiple and/or extended uses in heated cooking. Therefore, it is desirable to easily remove the bowl unit 38 for cleaning of the interior portion 40 that contacts the food product in particular. The cleaning can be beneficially conducted in an automatic dishwashing appliance or can be washed by hand in a kitchen sink. The base unit 36 itself is also preferably removable from the bowl unit 38 for cleaning, etc. The bowl unit 38 can be held to the base unit 36 by gravity in some embodiments, or the bowl unit 38 and base unit 36 can be snapped or otherwise fastened together such as including mechanical fasteners, release mechanisms, or the like. Further, the control unit 24 and heating unit 60 are preferably removable from the cooking vessel 34 entirely by removing fasteners 48 (see FIG. 3) that hold a control unit removable panel 46 (including any other components attached thereto) to the base unit 36. For example, the control unit 24 may comprise a number of components, including a control knob 30 or other user-manipulated device/display and control circuitry and/or a microprocessor or other integrated circuitry, a power unit 50 and connectivity features to connect with the heating unit 60, all mounted, directly or indirectly, to a top surface of the removable panel 46 (See FIGS. 10 and 11). The fasteners 48 can be screws as shown, or can include other mechanical fastening arrangements and types, such as snap-fit fasteners and the like. A user can therefore easily separate the portions of the modular cooking appliance 10 that may require cleaning without requiring also placing other portions in the dishwasher, for example.

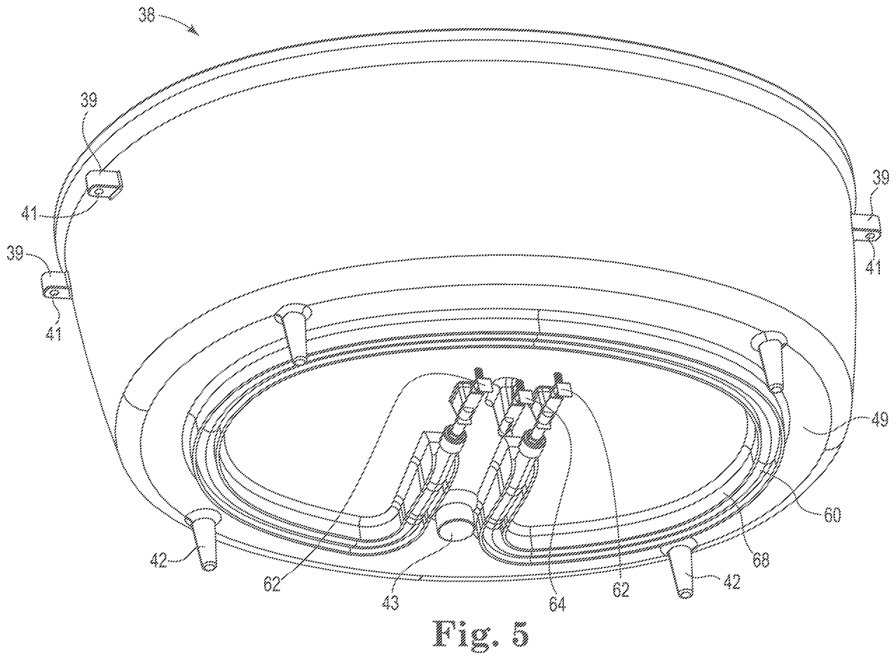

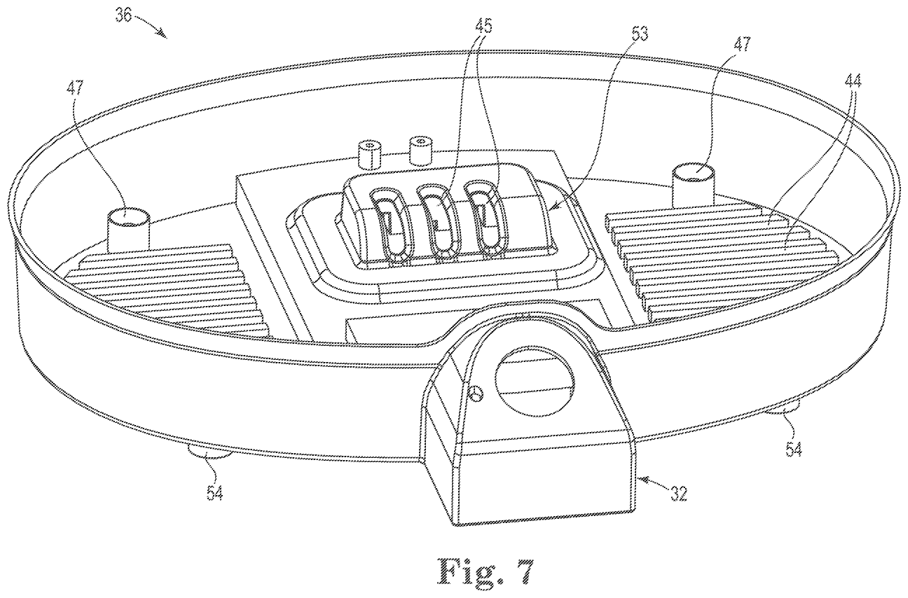

The bowl unit 38, as shown best with respect to FIGS. 4 and 5, has an interior 40, flanges 39 for attachment to handles 14, and apertures 41 in the flanges 39 for receiving a screw or other fastener 15 for attaching the handles 14 to flanges 39 of the bowl unit 38. A lower portion 49 of the bowl unit 38 also can include one or more generally downwardly-extending bowl standoffs 42 (e.g., 4 as shown) that are configured to interface with a counterpart female portion 47 (see, e.g., FIG. 7) of the base unit 38 to stabilize mounting of the bowl unit 38 to the base unit 36, and/or to guide installation of the bowl unit 38 to the base unit 36 in a correct alignment and position by a user. In some embodiments, the bowl standoffs 42 are gravity or friction fit to the corresponding female portions 47, and in other embodiments a mechanical fastener or the like can hold the bowl unit 38 to the base unit 36 until a user desires to separate the modular components.

The bowl unit 38 can be a single unit comprising various layers and/or substances, such as polytetrafluoroetbylene (PTFE), enamel, aluminum (e.g., anodized), stainless steel, among various other materials and compositions. In some embodiments, the interior 40 of the bowl unit 38 is coated, with e.g., a non-stick coating to reduce adhesion to a food product during cooking. With reference to FIG. 5, the lower portion 49 of the bowl unit 38 also preferably includes one or more channel(s) 68 that is a recess in the base unit 36 that is shaped and contoured to substantially conform to the heating unit 60. Such an arrangement allows the heating unit 60 to be properly positioned for use and the heating unit 60 can be separably removed from the channel 68 of the bowl unit 38. The channel 68 is preferably formed of the same material and integral with the bowl unit 38 and can improve conductive heat transfer from the heating unit 60 to the bowl 38 and a food product therein. In other embodiments, the heating unit 60 can instead be fully hidden and/or integrated with the bowl unit 38. Still with reference to FIG. 5, the bowl unit 38 can include one or more center bowl supports 43 (one as shown) that can also interface with the base unit 36 to support a food product within the interior 40 of the bowl unit 38.

With reference now to FIG. 7, one or more center openings 45 of the base unit 36 are shown with certain other components removed. Center openings 45 can be shaped, sized, and configured to allow portions of the heating unit 60 to pass through the base unit 36. The center openings 45 can permit the heating unit 60 to connect to the power unit 50 (see, e.g., FIGS. 10 and 11) mounted below a raised channel portion 53 of the base unit 36. The center openings 45 of the base unit 36 can further support the heating unit 60 and guide placement of the heating unit 60 during and/or after assembly of the modular heating appliance 10. In some embodiments, one or more of the center openings 45 can also permit at least some convective thermal transfer between various components and/or parts of the modular heating appliance 10. Control housing 32 is preferably formed with the base unit 36 and provides a space open from below within which components of the control unit 24 (discussed below) can fit, or which user features can be mounted. The control housing 32 also preferably is formed to include a space open from above or front through which a knob 30 of the control unit 24 can protrude and/or be accessed by a user.

A simple, detachable interface between a separable bowl portion 38 and base unit 36 is contemplated. Still with reference to FIG. 7, as shown, one or more generally cylindrical supporting feet 54 protrude downward (and optionally upward) from the base unit 36 to elevate the base unit 36. Each supporting foot 54 can be substantially cylindrical and/or hollow and can also include a female portion 47 at an upper portion of the supporting foot 54. Alternatively the supporting foot 54 and/or the female portion 47 and standoff can be prismatic, pyramid-like, or other non-cylindrical shapes. Therefore, the supporting feet 54 can beneficially serve both the purpose of stably supporting the base unit 36 on a resting surface, and also the purpose of providing a guiding female portion 47 for precise positioning of the bowl unit 38 with respect to the base unit 36. Each supporting foot 54 can include an opening that penetrates the base unit 36, and each female portion 47 can be shaped and configured to receive a corresponding bowl unit standoff 42. In some examples each female portion 47 can have a frustoconical opening configured to receive a corresponding, complementary frustoconical bowl unit standoff 42. A frustoconical interface can beneficially facilitate positioning and attachment of the bowl unit 38 to the base unit 36. Other corresponding female portion 47 and bowl unit standoff shapes and configurations are also contemplated herein. A corresponding number of bowl unit standoffs 42 and female portion 47 are shown; however any number of either is also contemplated. The female portions 47 can be independently provided without association with the supporting feet 54. Preferably, the base unit 36 comprises at least one female portion 47 corresponding to each bowl unit standoff 42. In other embodiments, the bowl portion 38 can include one or more female portions 47 that instead receive a corresponding standoff from the base unit 36, among other possible combinations, variations, and alternative configurations.

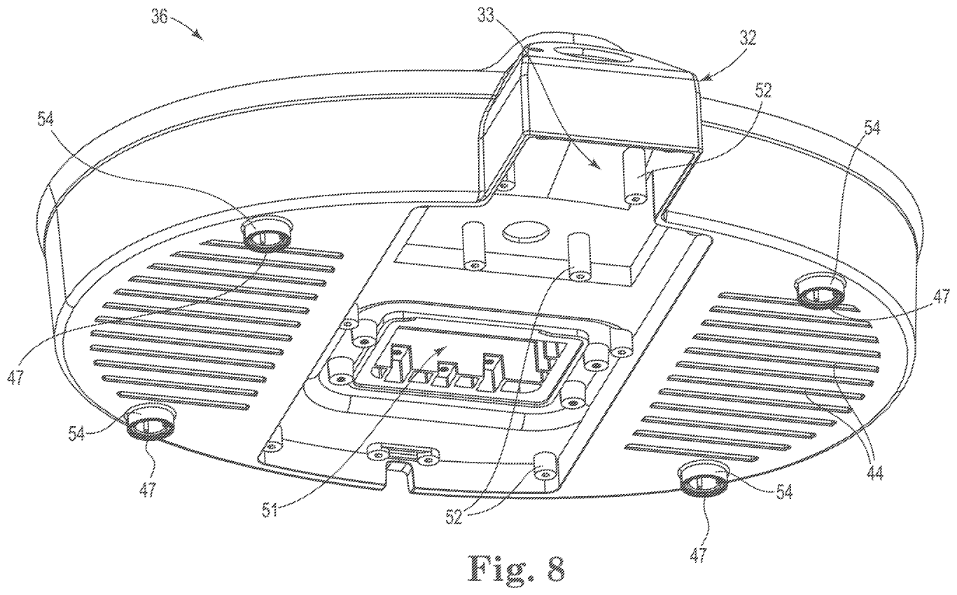

Turning now to FIG. 8, a bottom side of the base unit 36 is shown with the control unit removable panel 46 removed, exposing a plurality of control assembly standoffs 52, a control recess 33, and a center recess 51 of the base unit 36. The control assembly standoffs 52 can receive fasteners 48 for attachment of control unit removable panel 46 (and control unit 24) to the base unit 36. A plurality of control assembly standoffs 52 can provide a more rigid and/or secure assembly when the removable panel 46 is installed and fastened to the base unit 36. As shown, a bottom side of the base unit 36, including the control recess 33 and the center recess 51, is shaped and sized to receive control unit 24 components. The center recess 51 in base unit 36 is preferably shaped and sized to receive power unit 50 and/or at least part of the heating unit 60 when assembled. The center recess 51 can be adjacent to center openings 45 in the base unit 36. The control recess 33 is also accessible when the removable panel 46 is removed. The control recess 33 is preferably shaped and sized to receive control components 26 or 28, and/or control knob 30 of the control unit 24.

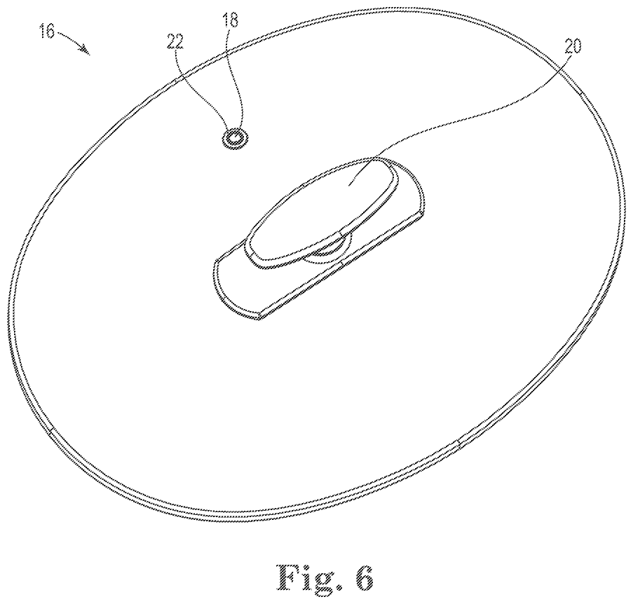

As shown best with reference to FIGS. 4 and 6, the lid 16 is removable from a resting position upon an upper rim 56 of the bowl unit 38 of the cooking vessel 34. The lid 16, when installed or removed, can selectively expose or cover the interior 40 of the bowl unit 38. With the lid 16 at least partially removed from the bowl unit 38, a user can then add or remove food to/from the cooking vessel 34 accordingly. Lid 16 preferably includes a handle 20 and optionally includes an aperture 18, which can be configured to receive a temperature probe in certain embodiments. The handle 20 can be textured in order to improve gripping characteristics. The lid 16 can comprise a lid hanger, e.g., the handle 20, itself. Aperture 18 can further include a grommet 22 fitted to the aperture 18. The grommet 22 can be silicone, rubber, or any other elastomeric substance. Lid 16 can be transparent and can comprise glass for other non-handle 20 portions. The glass of lid 16 can preferably be tempered glass.

With reference now to FIG. 3, the base unit 36 is shown from below with the removable panel 46 installed. A bottom surface of the base unit 36 can include side vents 44, supporting feet 54 (which can be connected to or integrated with female portions 47 that are configured to receive bowl unit standoffs 42), and control unit removable panel 46 attached to the base unit 36 by one or more fasteners 48. One or more parts of the modular heating appliance 10 can produce heat, which in some cases could lead to undesirable hot spots. For example, a power unit 50 and/or control components 26 or 28 (see, e.g., FIGS. 10 and 11) can be fastened to the removable panel 46, and can create heat when in use. The heating unit 60 will also create or otherwise emit heat. Therefore, for example, to reduce certain hot spots throughout the modular cooking appliance 10, various vents, such as side vents 44, can be beneficially included in various embodiments. In some embodiments, the base unit 36 is configured to thermally insulate and/or separate the heated cooking vessel 34 and heating unit 60 from a supporting surface, such as a counter top or table. The base unit 36 can be composed of various plastics, metals, phenolic materials, or any other suitable material. The base unit 36 as shown comprises the control housing 32 that protrudes from the cooking vessel 34, and provides a bezel for control knob 30 in embodiments that utilize manual adjustments of control unit 24. The control knob 30 can penetrate the control housing 32 and can protrude for easy adjustment by the user. Also shown is a portion of a power cord 66 that connects the control unit 24 to a wall power outlet via a plug (not shown). The power cord 66 can be fixed to control unit 24 or removable in various embodiments.

With reference now to FIG. 10, an example of an analog control unit 24A is shown. FIG. 11 shows a digital control unit 2413, which differs from control unit 24A only by including digital control components 28 in place of analog (and/or mechanical) control components 26. The analog control components 26 or digital control components 28 contemplated herein can also comprise a combination analog/digital control unit 24. The control unit 24 can include various programmed or programmable cooking functions. For example, cooking functions and modes can include a slow-cooker setting, a higher-heat setting, a lower-heat setting, a roast setting, a sous-vide setting, a saute setting, a sear setting, a rice setting, a boil setting, a manual temperature setting, manual or automatic timed settings, among various other multi-cooker settings ranging from general to specific, fully manual to fully automatic, and the like.

For various functions of embodiments described herein, an on/off duty cycle can be selected through the control unit 24. For the digital control unit 24B of FIG. 11, the power unit 50 is electrically connected with various digital components 28 that may not be physically connected to knob 30. Control unit 24B can operate at least partially automatically according to various inputs. The digital components can include one or more circuits, such as one or more microprocessors or other circuitry. In such digital control unit 24B various cooking functions and modes can be controlled from various firmware, software, and/or any programmable computer or electronic storage or processing components, etc. In some examples, the digital control unit 24B can lack a physical connection between the knob 30 and the power unit 50. For the analog control unit 24A, various mechanical and/or analog components can provide a signal to the heating unit 60 and the power unit 50 without the use of digital or computer-based components. Various components of the analog control unit 24A can include various manual controls, mechanical linkages, switches, sensors, snap-action or thermally-activated components, analog circuitry, etc. Yet further embodiments can utilize some digital and some analog components in a control unit 24.

Control unit 24 (collectively for control unit 24A and 24B), can also comprise the power cord 66, the heating unit 60, and heating unit electrical leads 62 used to selectively power the heating unit 60. Example control units 24 can be partially integrated with the removable panel 46 in various embodiments. Digital control unit 24B as shown can include a non-mechanical, linkage-free digital control between control knob 30 and power unit 50. The power unit 50 or other part of the control unit 24 can include a controller configured to regulate power produced by the power unit 50. The power unit 50 can be fastened directly or indirectly to removable panel 46. The power unit 50 can interface with the heating unit 60 and the power cord 66. The power unit 50 can receive alternating current electrical power via power cord 66 and transform/rectify (if necessary) alternating current to direct current for use with heating unit 60. Heating unit 60 can include a Calrod, quartz, or any other resistive heating unit can be used herein. In one embodiment, the heating unit 60 includes a Calrod heating element with a rating of 800 Watts or more, as powered by the power unit 50. An additional electrical lead 64 can also be included in control unit 24, and can provided additional power, grounding, and/or sensing functionality to control unit 24.

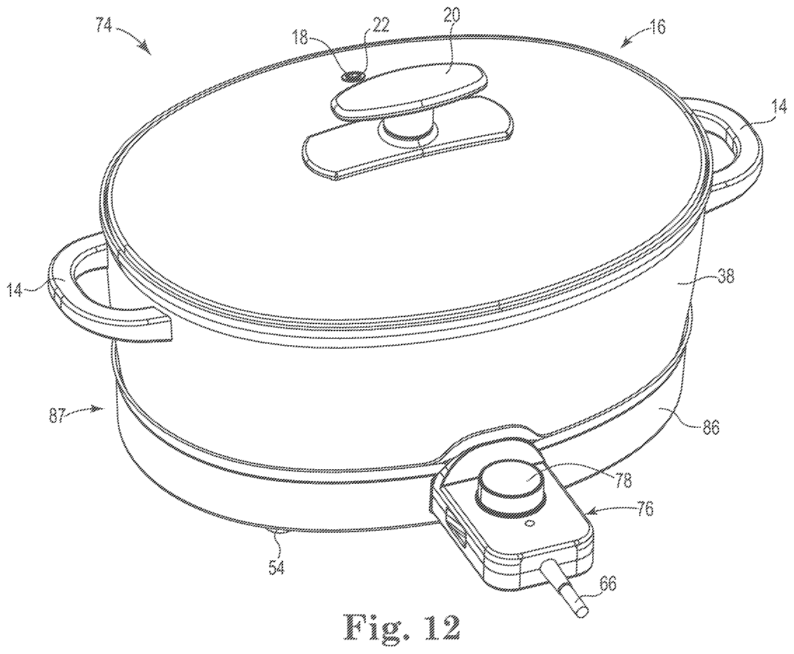

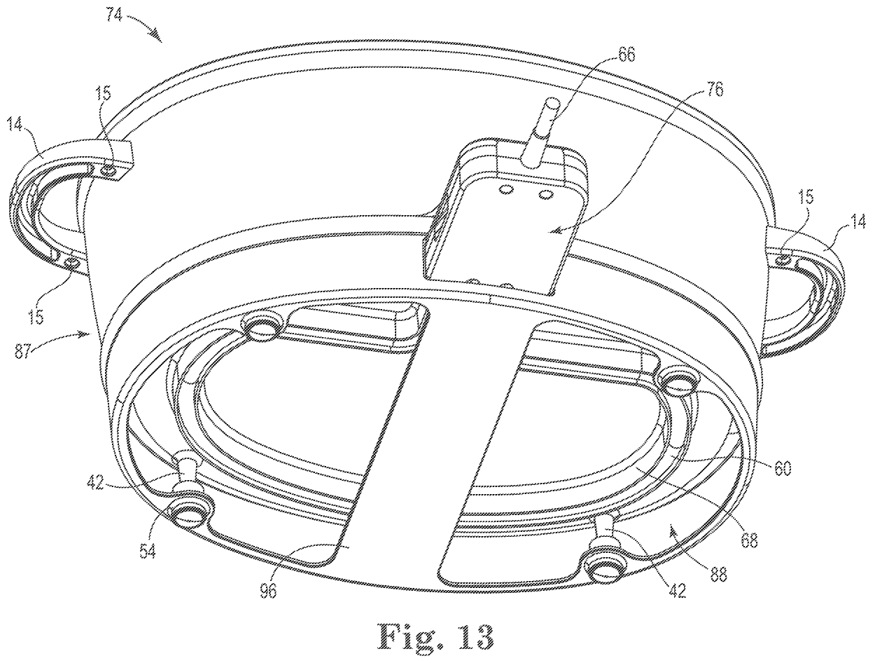

A second, alternative example of a modular cooking appliance 74 in shown with respect to FIGS. 12-16. Unless specifically stated otherwise, it is understood that the alternative modular cooking appliance 74 includes the same features and functionality as the modular cooking appliance 10, described above. Modular cooking appliance 74 is an example of a probe control based example of the present disclosure. An alternative embodiment of a cooking vessel 87 including an alternative base unit 86 with an open bottom end 88 and base structural cross-member 96 is also shown.

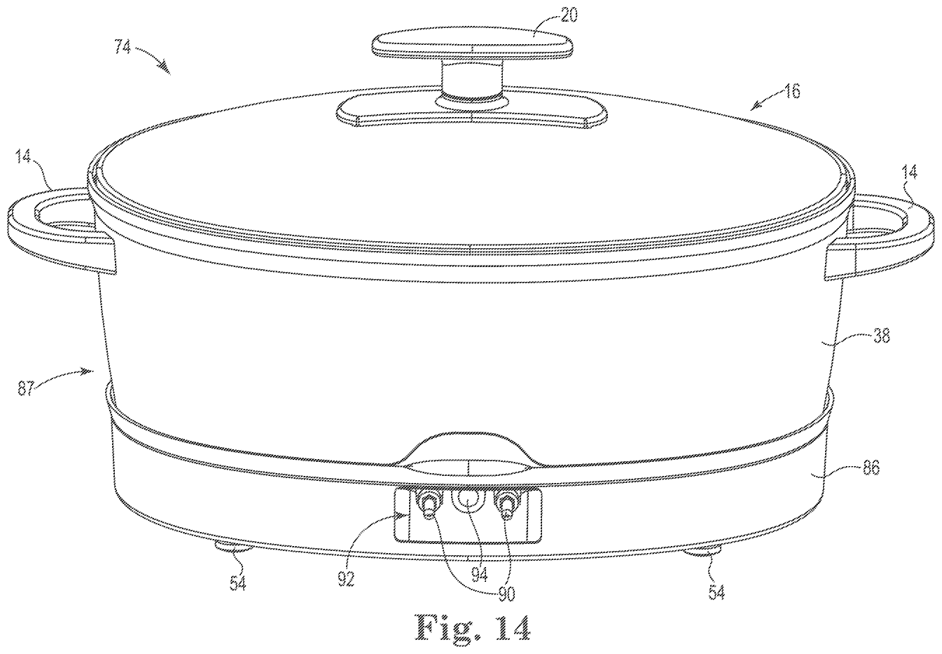

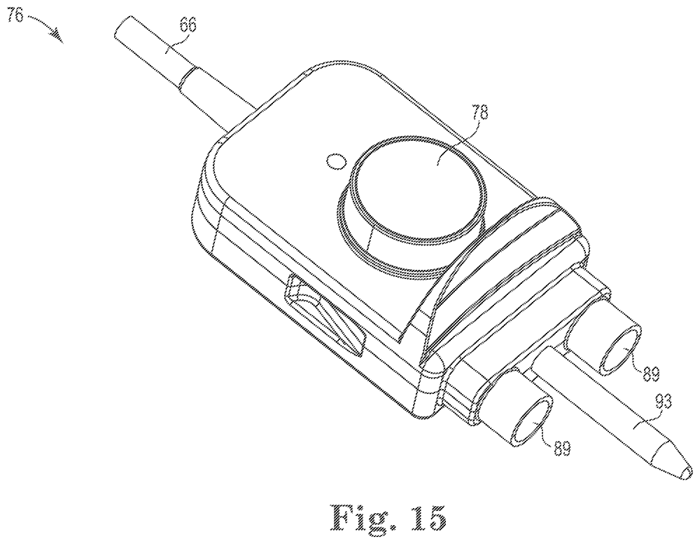

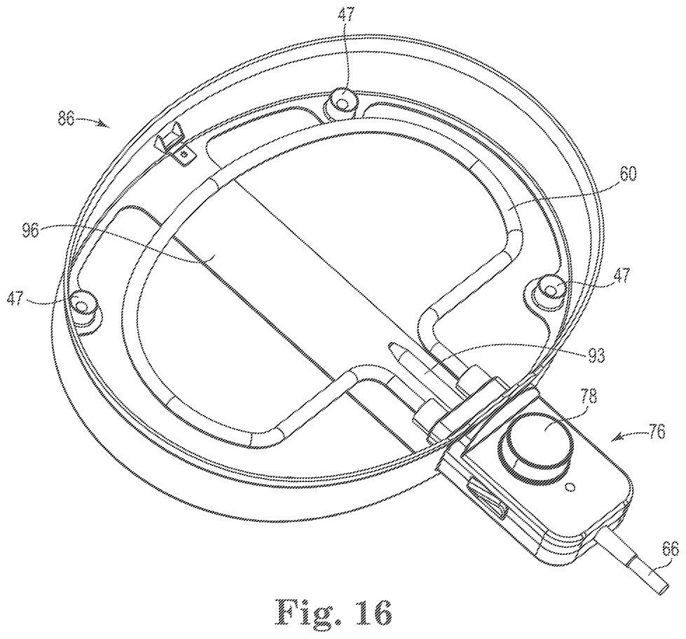

It may be desirable to have a more easily disconnectable connection between control/power componentry and various other portions of the modular cooking appliance 74. For example, a user may desire to clearly separate components of the modular cooking appliance 74 that are safe for washing in a dishwasher, versus components that should not be washed in a dishwasher. A probe-based configuration can facilitate disconnection of various components in some embodiments. As shown with reference to FIG. 15, a removable probe unit 76 can include a knob 78 (or digital or automatic control input panel), a power cord 66, probe power interfaces 89, and a probe thermistor protrusion 93 or other component or connection. The probe unit 76 can utilize a friction fit to provide a secure, yet removable connection to the modular cooking appliance 74. As shown with reference to FIG. 14, the modular cooking appliance 74 when the probe unit 76 is removed reveals an opening 92 in the base unit 86 configured to receive at least a portion of the probe unit 76. Also shown are probe-receiving interface connections 90, which are configured for use in transferring power from the probe unit 76 to the heating unit 60. A probe thermistor protrusion receiving opening or cavity 94 is also shown and configured to receive the probe thermistor protrusion 93 of the probe unit 96. The probe thermistor protrusion 93 can thermally interface with the receiving opening 94 in order to create a conductive thermal connection between the bowl unit 38 and the probe unit 76. With reference to FIG. 16, the heating unit 60 is shown directly connected to the probe unit 76, e.g., to sense a cooking temperature during operation. In such an embodiment, the probe unit 76 would then include the function of the control unit 24, power unit 50, and all other user interfaces.

The present invention has now been described with reference to several embodiments thereof The foregoing detailed description and examples have been given for clarity of understanding only. No unnecessary limitations are to be understood therefrom. It will be apparent to those skilled in the art that many changes can be made in the embodiments described without departing from the scope of the invention. The implementations described above and other implementations are within the scope of the following claims.

What is claimed is:

1. A modular cooking appliance, comprising:
a cooking vessel having a bowl unit, a lower portion of the bowl unit in contact with a heating unit having an electrical connection;
a base unit attachable to and configured to support the cooking vessel;
a control unit operatively connected to the electric connection of the heating unit, wherein the control unit comprises one or more controls, and wherein the control unit is configured to interface with and selectively provide power to the heating unit via the electrical connection such that the bowl unit of the cooking vessel is selectively heatable by the heating unit.

2. The modular cooking appliance of claim 1, wherein the power unit operatively connects to the heating unit of the cooking vessel using a probe-like connection.

3. The modular cooking appliance of claim 1, wherein the exposed electrical connection comprises at least two electrical leads.

4. The modular cooking appliance of claim 1, wherein the cooking vessel is configured to be submersible in liquid when disconnected from the control unit.

5. The modular cooking appliance of claim 1, wherein the control unit comprises a temperature or time based cooking control.

6. The modular cooking appliance of claim 1, wherein the control unit is configured to receive an input via analog or digital interface.

7. The modular cooking appliance of claim 1, wherein the control unit is configured to receive an input via manual or automatic interface.

8. The modular cooking appliance of claim 1, wherein the control unit selectively provides the modular cooking appliance functionality of a multi-cooker or a slow cooker.

9. The modular cooking appliance of claim 1, wherein the bowl unit of the cooking vessel comprises only anodized aluminum.

10. The modular cooking appliance of claim 1, wherein the cooking vessel comprises at least one handle.

11. The modular cooking appliance of claim 1, further comprising a lid configured to rest on an upper rim of the bowl unit in order to at least partially seal the open top of the bowl unit of the cooking vessel.

12. The modular cooking appliance of claim 11, wherein the lid further comprises at least an aperture.

13. The modular cooking appliance of claim 1, wherein the control unit comprises a power unit configured to receive alternating current from a wall power socket via a power cord and convert the alternating current to direct current for use with the heating unit.

14. The modular cooking appliance of claim 1, wherein the heating unit is at least partially embedded or recessed within a channel of the lower portion of the cooking vessel.

15. The modular cooking appliance of claim 1, wherein the heating unit is a resistive heating unit.

16. The modular cooking appliance of claim 1, wherein the electrical connection of the heating unit is external to the cooking vessel.

17. The modular cooking appliance of claim 1, wherein the base unit is configured to thermally insulate the cooking vessel and heating unit from a supporting surface.

18. The modular cooking appliance of claim 1, wherein the control unit comprises a second electrical connection complementary to the electrical connection of the heating unit.

19. The modular cooking appliance of claim 1, wherein the control unit is removably connectable to the heating unit.

20. A method of making a modular cooking appliance, comprising:
providing a cooking vessel having a bowl unit,
attaching a heating unit to the bowl unit, wherein the heating unit when attached is in contact with a lower portion of the bowl unit, and wherein the heating unit has an electrical connection;
providing a base unit attachable to and configured to support the cooking vessel; and
operatively connecting a control unit to the electric connection of the heating unit, wherein the control unit comprises one or more controls, and wherein the control unit is configured to interface with and selectively provide power to the heating unit via the electrical connection such that the bowl unit of the cooking vessel is selectively heatable by the heating unit.
